(19) United States
(12) Patent Application Publication
(10) Pub. No.: US 2002/0112619 A1
(43) Pub. Date: Aug. 22, 2002

(54) Device for imprinting bottle closures

(76) Inventor: Wilfried Philipp, Kornwestheim (DE)

Correspondence Address: William M. Hanlon, Jr., Young & Basile, P.C., Suite 624, 3001 West Big Beaver Road, Troy, MI, 48084, US

(21) Appl. No.: 10/080,243

(22) Filed: Feb. 21, 2002

(30) Foreign Application Priority Data
Feb. 22, 2001 (DE) 201 03 145.0

(51) Int. Cl. B41F 17/00

(52) U.S. Cl. 101/35

(57) ABSTRACT

A device for a imprinting bottle closures has a feeder, a conveyance device, a printing station and removal and unloading equipment. The conveyance device has a holder for gripping the bottle closures around their periphery. The holder is configured as a nest and may be made up of at least two jaws, one of which may have a bottle closure locating surface. One of the jaws may be movable under adjustable spring pressure. The jaws may also grip over only a part of the height of the periphery of the bottle closure.

### BACKGROUND

The invention relates to a device for imprinting bottle closures, specifically a pad-printing machine, having feeder equipment, a conveyance device, a printing station and removal and unloading equipment for the bottle closures.

Printing machines for imprinting bottle closures which are produced from metal or plastic have been employed for decades. The printing processes used are offset, relief printing, flexographic printing, pad printing etc., where the bottle closures are imprinted or decorated in a single color or in several colors. These machines operate with a conveyance device which has what are called locating mandrels which serve to position the screw-on closures arriving from the feeder equipment and carry them continuously under the printing stations by means of the conveyance device so that they can be imprinted. This conveyance device requires suitable mandrels for each bottle closure design. The bottle closures are installed onto these mandrels. The bottle closure has to be held by the mandrel without any free-play so that it does not move during the printing process. In the case of some embodiments, the mandrel has to transport the bottle closure upside-down so that a certain amount of static friction is required by which the bottle closure is held to the mandrel with a specific force. Since the internal shape and the material properties of the bottle closure vary widely and the bottle closures are furnished with sealing inserts, sealing lips, pull-rings etc., the mandrels first of all have a shape which is precisely matched to each bottle closure, and each mandrel must be manufactured to a high degree of precision, which is why mandrels of this type are relatively expensive.

A serious disadvantage of these mandrels is the fact that they contact the inner lining of the bottle closure so that there is first of all a risk of damaging the highly sensitive closing mechanism, and beyond that the risk of contaminating the bottle closure. This can happen as the result of entraining dust, bacteria and other disease-causing agents. Entrained dust is pressed against the inner surface particularly while the bottle closure is being pressed onto the mandrel, so that it eventually ends up in the bottle. Additionally, when the bottle closure is being pressed onto the mandrel, the seal lip, which is supposed to effect a pressure-tight seal of the interior of the bottle to the environment, can be damaged. Above all, with large inside tolerances a great risk exists of damaging the bottle closure, or of the seating on the mandrel being affected by free play so that precise registration printing cannot be carried out by printers operating in series. Seating suffering from free play causes particular problems in polychrome printing.

The object of the invention is therefore to provide a device of the type described above for imprinting bottle closures, with which first of all the bottle closures can be held more securely and with less damage, and which second of all prevents contamination of the bottle closures.

### SUMMARY

This object is attained under the invention in the case of a device of the type described above through the conveyance device having holding devices to grip the bottle closures around their periphery.

With the design under the invention, the advantage gained is that mandrels are no longer inserted into the bottle closure but rather the periphery of the bottle closures is gripped by means of holding devices. The outside of the bottle closure is non-critical for contamination and, above all, the sensitive closing mechanism on the inside of the bottle closure is not damaged. A considerable advantage of the device under the invention is furthermore that a change in the inner shape of the bottle closure does not require any change in the holding devices. The most varied shapes of bottle closure can be held in position with one and the same holding device. With the device under the invention as many as 300,000 bottle closures can be imprinted per hour.

The device under the invention has the additional considerable advantage that the bottle closures can now also be given a corona pretreatment, which achieves better results in printing and adhesion. When mandrels are used, corona pretreatment is not possible because the high energy feed and the locating mandrel directly under the cap surface would result in softening of the plastic, which would damage the bottle closure. An additional advantage is also seen in the fact that caps which cannot be chucked by means of a mandrel can now be chucked and then imprinted. Bottle closures of this type, for example, have a pouring lip, measuring device, etc., inside.

In a further development it is envisioned that the holding devices are configured as nests. This has the considerable advantage that the positioning of the bottle closures can be implemented relatively simply because the bottle closures can be placed into the nests by means of the automatic feeder equipment without difficulty.

Under the invention, the holding devices are configured for one or several bottle closures. Depending on the application, one bottle closure or several bottle closures simultaneously can be placed into a holding device and chucked. This has the advantage that volume is increased in accordance with the bottle closures chucked in the holding device at the same time.

A preferred embodiment provides for the holding devices to be formed from at least two jaws. This has the considerable advantage that clamping or chucking forces can be exerted on the bottle closures with these jaws to hold them securely in position. In addition, the jaws can be furnished with surfaces which increase friction so that high holding forces can be achieved even with low clamping forces.

It is advantageous for at least one jaw to have a V-shaped locating surface. The locating surface shaped like a V has the considerable advantage that the bottle closure, which has a basically cylindrical shape, centers itself automatically. Minor tolerances in the circumference and in shape have only a minimal or no effect.

In order to achieve the simplest possible construction for the holding device, the intention under the invention is for at least one jaw to be mounted movably in the direction of the bottle closure. The drive for this movable jaw can be mechanical, pneumatic, hydraulic or electromagnetic. Bottle closures with different diameters can be chucked by means of this movably mounted jaw. In this way the holding device is universally utilizable for the most varied bottle closures. Changes dictated by design have no effect so that the same holding device can be used afterwards as before.

Minor differences in tolerances in the circumference or in the dimensions of the bottle closure ensure that the required holding force is exerted, since the invention arranges for the movable jaw to be in contact with the periphery of the bottle closure, specifically under adjustable spring pressure. This spring pressure is applied, for example, by a helical compression spring, a pneumatic cylinder, a hydraulic cylinder, an electromagnetic clamping system or other energy storage unit.

For example, in order to keep the area of pull-rings, which can have a larger diameter than the main body of the bottle closure, free from chucking forces, it is proposed under the invention that the jaws grip only over one part of the height at the circumference of the bottle closure. Specifically, the jaws grip in the area of the upper half, or upper third respectively of the bottle closure. This has not only the advantage mentioned above, but also results in the bottle closures being held in position relatively immovably in the area of its pressure surface, that is, in the area of the cap surface.

Under the invention the holding device is intended for the printing plate, the linear conveyor or the drum for various printing machines. So all models of printing machines can be equipped with the new holding device.

Preferably the holding devices are furnished with devices for automatic chucking and release of the bottle closures. Relative large quantities can be realized for the printing process as a result of this automation.

### BRIEF DESCRIPTION OF THE DRAWING

Additional advantages, features and details of the invention emerge from the following description, in which particularly preferred embodiments are described with reference to the drawing. The features mentioned in the drawing as well as in the claims and in the description can be fundamental to the invention individually or in any combination. In the drawing:

FIG. 1 shows a cross-section view I-I in accordance with FIG. 2 through a holding device with two bottle closures in place;

FIG. 2 shows a plan view in the direction of arrow II in FIG. 1 of the holding device;

FIG. 3 shows a conveyance device of a pad printing machine configured as a rotary table;

FIG. 4 shows a conveyance device of a pad printing machine configured as a drum; and

FIG. 5 shows a conveyance device of a pad printing machine configured as a linear conveyor.

### DETAILED DESCRIPTION

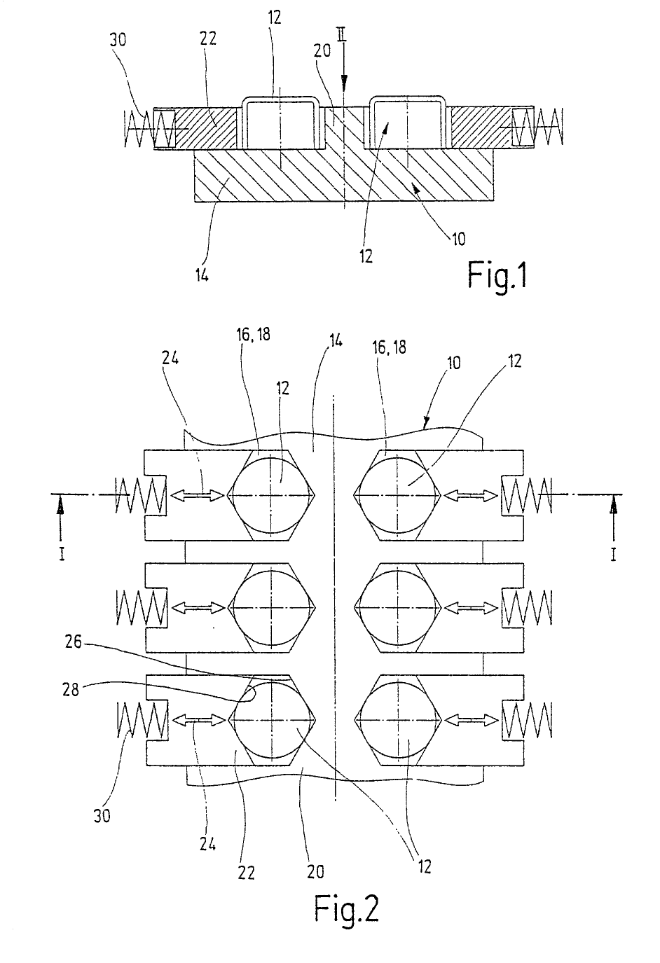

FIGS. 1 and 2 show an embodiment of a holding device 20, with which bottle closures 12 can be held and located in position so that they can subsequently be put through a printing process. The holding device 10 has a base 14 which acts as a support for the bottle closures 12. The base 14 has a plurality of recesses 16 which forms nests 18 for the bottle closures 12. Each nest 18 has two jaws 20 and 22, where jaw 20 forms part of the base 14. Jaw 22 is carried movably in the direction of the double-headed arrow 24, which allows the size of the nest 18 to be varied and adapted to various sizes of bottle closure 12. Centering of the bottle closure 12 is achieved by both jaws 20 and 22 having a V-shaped locating surface 26 and 28.

Placing the jaw 22 against the bottle closure 12 is performed mechanically, pneumatically, hydraulically or electromagnetically and is assisted by a spring 36. In this way a constant holding force is ensured. In addition, the spring 30 has the advantage that a drive for the jaw 22 is required only to open, that is to say, compress the spring 30, so that the bottle closure 12 can be held without an additional drive, that is to say, solely by means of the spring 30. Opening and closing of the holding device 10 can therefore be carried out by means of stationary drives in the feeder and in the removal and unloading equipment, as the stationary drives engage the moving holding devices 10 being carried past by means of suitable clutches.

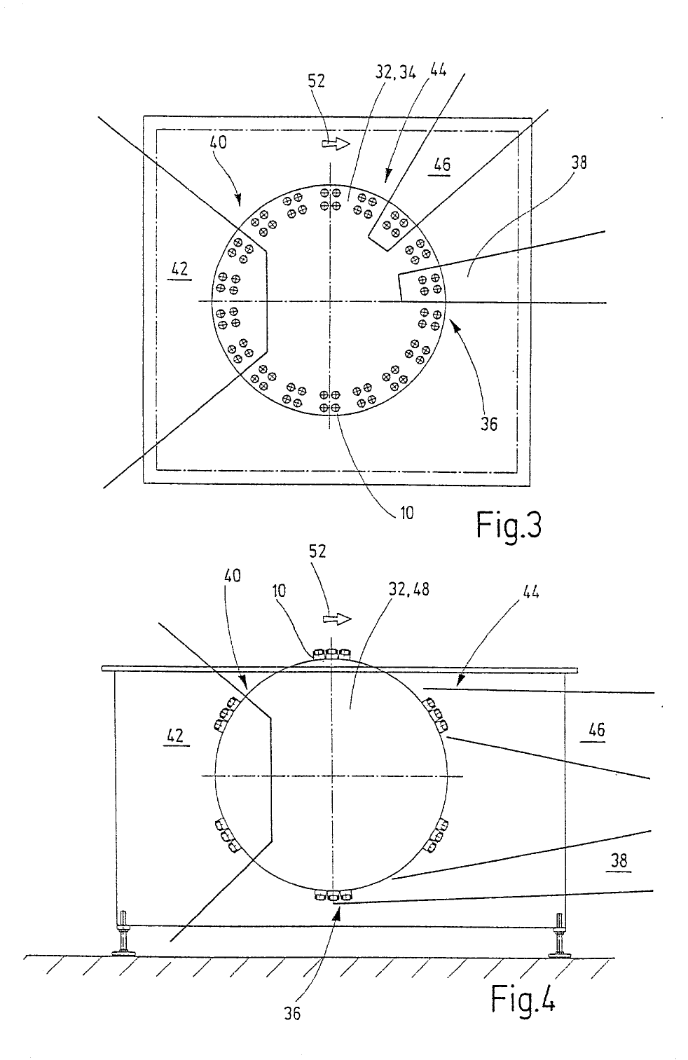

FIG. 3 shows a conveyance device 32 which is configured as a rotary table 34. In this embodiment, for example, the feeder 38 is located in area 36, the printing station is in area 40, and the removal and unloading equipment is in area 44. The designs of these types of feeder 38, printing stations 42 and removal and unloading equipment 46 are generally known and are therefore not described in greater detail.

FIG. 4 shows an embodiment in which the feeder 32 is configured as a drum 48. The appropriate feeder 38, printing station 42 and removal and unloading equipment 46 are located in areas 36, 40 and 44 respectively.

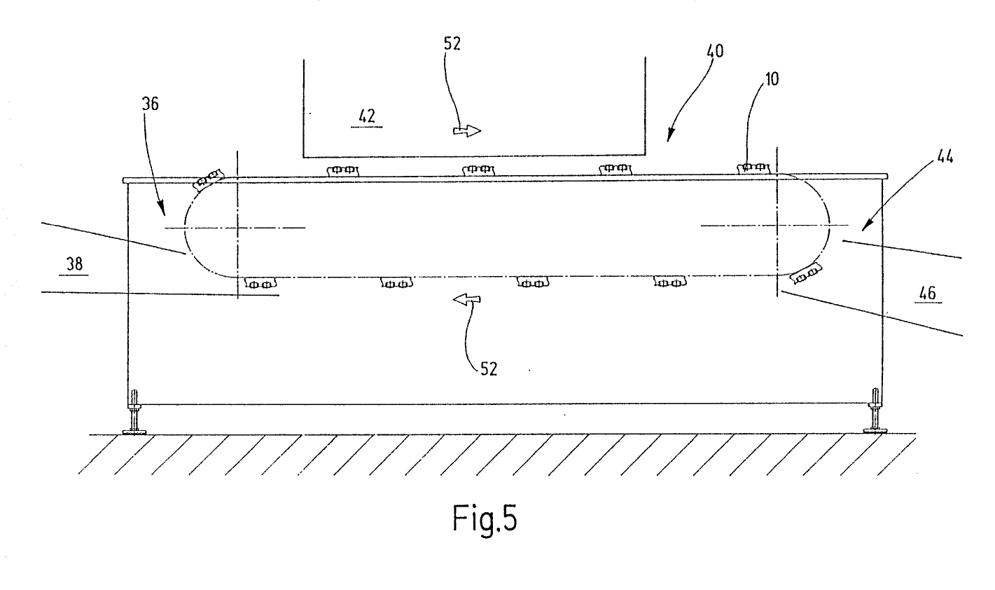

FIG. 5 shows a conveyance device 32 which is configured as a linear conveyor 50. Here too, the feeder 38, printing station 42 and removal and unloading equipment 46 are located in areas 36, 40 and 44 respectively. The direction in which the conveyance device 32 circulates is shown in each case by an arrow 52.

What is claimed is:

1. Device for imprinting bottle closures (12), specifically a pad printing machine, having a feeder (38), a conveyance device (32), a printing station (42) and removal and unloading equipment (46) for the bottle closures (12), characterized in that the conveyance device (32) has holding devices for gripping the bottle closures (12) around their periphery.

2. Device in accordance with claim 1, wherein the holding devices are configured as nests (18).

3. Device in accordance with one of the preceding claims, wherein the holding devices are configured for one or more bottle closures (12).

4. Device in accordance with one of the preceding claims, wherein the holding devices are made up of at least two jaws (20, 22).

5. Device in accordance with claim 4, wherein at least one jaw (20 or 22) has a V-shaped locating surface (26 or 28).

6. Device in accordance with claim 4, wherein at least one jaw (20 or 22) is mounted moveably in the direction of the bottle closures (12) and can be specifically adjusted mechanically, hydraulically, pneumatically and/or electromagnetically.

7. Device in accordance with claim 6, wherein the moveable jaw (20 or 22) is in contact with the periphery of the bottle closure (12) under specifically adjustable spring pressure (30).

8. Device in accordance with one of the claims 4 to 7, wherein the jaws (20 and 22) grip over only one part of the height on the periphery of the bottle closure (12), specifically the half facing the pressure surface, specifically one-third of the bottle closure (12).

9. Device in accordance with one of the preceding claims, wherein the holding device is installed on a conveyance device (32) configured as a rotary table (34), linear conveyor (50) or drum (48).

10. Device in accordance with one of the preceding claims, wherein the holding devices are furnished with equipment for automatic chucking and release of the bottle closures (12).
